(19) United States
(12) Patent Application Publication
(10) Pub. No.: US 2009/0173915 A1
(43) Pub. Date: Jul. 9, 2009

(54) Light-storing phosphor

(76) Inventors: Soshchin Naum, Changhua City (TW); Wei-Hung Lo, Taipei City (TW); Chi-Ruei Tsai, Taipei City (TW)

Correspondence Address: The Weintraub Group, P.L.C., 28580 Orchard Lake Road, Suite 140, Farmington Hills, MI, 48334, US

(21) Appl. No.: 12/007,250

(22) Filed: Jan. 8, 2008

(30) Foreign Application Priority Data
Jan. 8, 2007 (TW) 096100707

(51) Int. Cl. C09K 11/86

(52) U.S. Cl. 252/301.4 H

(57) ABSTRACT

A light-storing phosphor prepared from a matrix (host) based on the element of aluminate of group IIA and activated by Eu⁺² and La⁺³, and characterized in that the composite of the light-storing phosphor contains group VII elements F⁻¹, Cl⁻¹, Mn⁺² and has the total stoichiometric equation of: (Me₁₋ₓEuₓO)_{α}(Al_{2-y-z}Ln⁺³_{y}Mn⁺²_{z}O_{3-z}Hal_{z})_{β}, in which Me=Sr and/or Ba and/or Ca and/or Mg, Ln=Dy and/or Nd and/or Ce, Hal=F and/or Cl. The invention also provides a light-storing phosphor preparation method, which is based on an alkali fusion product and which employs a heat treatment to hydroxides under the presence of a gas of weak reduction type to maintain fine dispersibility of the product.

### BACKGROUND OF THE INVENTION

1. Field of the Invention

The present invention relates to light emitting technology and more particularly, to a light-storing phosphor and its preparation which uses aluminates of IIA group metals as the matrix in which the powder shows a strip-like ellipse configuration, having a particle size about 3˜4 times of the maximum wavelength of the radiation spectrum of the phosphor.

2. Description of the Related Art

Normally, light-storing phosphors are inorganic materials having a long time afterglow. These materials are called ultra-long-time phosphor or materials that glow in the dark. At the present time, these materials are widely used for emergency applications, fixed signal implements, automatic illumination, building number indication systems in municipal construction, fire safety equipment in transportation industry, marine petrol exploitation platform, and many other fields.

The known three generations of light-storing materials are classified subject to their persistence or light-storing message: 1. Measurement using minutes, from several tens minutes to one hour; 2. Measurement using hours, maximum 5˜6 hours 3. More longer time.

The first generation light-storing material is based on certain chemical substances that comprise the matrix (host) of alkaline-earth metal sulfide or selenium, including CaS:EuSm, CaS:BiSm, etc. Based on these compounds, phosphors of all base colors have been created, including purple and dark red. However, these materials are not usable for industrial applications due to their native defect, i.e., low hydrolyte stability under the effect of water and water solution.

A second generation light-storing material comprises zinc sulfide and cadmium sulfide as a matrix (host). The light persistence of second generation light-storing materials can be as long as 1˜5 hours. These materials are inexpensive. However, these zinc sulfide-based light-storing materials have never been intensively used due to the drawbacks of limited light storing capacity and low solar radiation stability (will become dark after several houses in radiation).

At the end of 20 century, ex-Soviet scientists and Chinese and Japanese chemists created a light-storing material based of the matrix (host) of alkaline-earth metal aluminates, having the total formula: MeAl₂O₄:Eu⁺²TR⁺³, in which TR⁺³=Dy⁺³, Nd⁺³, Ce⁺³. This new generation light-storing material has the characteristics of: 1. Long fluorescence persistence, 72˜96 hours; 2. High stability at high manufactured temperature (400˜1000° C.); 3. High powder dispersibility; and 4. Higher vapor sensitivity. This material still has certain limitations, such high powder dispersibility and water decomposable characteristics. This new generation light-storing phosphor is intensively used in industry, and its annual output is more than 100 tons.

The first patent relating aluminate-based phosphor belongs to NeMOTO Co., Ltd., Tokyo, Japan. The phosphor includes a matrix expressed by: Sr₂Al₂O₃:EuDy (see U.S. Pat. No. 5,424,006A, issued on Jun. 13, 1995). This phosphor has much longer high-luminance afterglow characteristics as compared with conventional zinc sulfide phosphors. This patent provides a base for analysis in the present invention. However, this phosphor still has drawbacks, including: 1. Very low luminance during last attenuation period (over 10 hours); 2. High dispersibility of granular composition, average particle size d_{cp}≧30 μm; and 3. Significant change of hydroxyl ion concentration in water upon contact with phosphor.

Soviet Union Patent No. 2194736 (issued on May 12, 2000) intended to overcome the drawbacks of the aforesaid new generation phosphor by means of adding group IV elements Zr, Hl, Tr to the composite. The added elements improve hydrolyte stability. However, the particle size is too large d_{cp}≧30 μm, limiting its application in certain fields. Further, under a standard radiation condition, the initial value of the luminance of this phosphor is L≦4 lm/m², not good enough.

The aforesaid drawbacks limit the application of phosphors. Therefore, it is desirable to provide a phosphor that eliminates the aforesaid drawbacks for broad application in light emitting technology and automatic illumination.

### SUMMARY OF THE INVENTION

The present invention has been accomplished to eliminate the drawbacks of the prior art techniques. It is therefore the main object of the present invention to provide a light-storing phosphor and its preparation, which uses aluminates of IIA group metals as the matrix in which the powder shows a strip-like ellipse configuration, having a particle size about 3˜4 times of the maximum wavelength of the radiation spectrum of the phosphor.

To achieve this and other objects of the present invention, the light-storing phosphor is prepared from a matrix based on aluminates of ground IIA metals and activated by Eu⁺² and La⁺³, wherein the phosphor contains group VII elements F⁻¹, Cl⁻¹, Mn⁺² and has the total stoichiometric equation of: (Me₁₋ₓEuₓO)_{α}(Al_{2-y-z}Ln⁺³_{y}Mn⁺²_{z}O_{3-z}Hal_{z})_{β}, in which Me=Sr and/or Ba and/or Ca and/or Mg, Ln=Dy and/or Nd and/or Ce, Hal=F and/or Cl.

Further, when stoichiometric index α=1, stoichiometric index β has two values, i.e., β=1 or β=1.75, and at this time, the atomic fraction value of the element entering cation and anion lattices is: x=0.001˜0.1, y=0.001˜0.25, z=0.001˜0.005.

Further, the symbol Me represents Sr, Ba, Ca, Mg, they compose ΣMe=Sr_{1-p-q-r}BaₚCa_{q}Mgᵣ, in which p≦0.2, q≦0.2, r≦0.1, because Ln⁺³=Dy and/or Nd and/or Ce, symbol Hal⁻¹ represents F⁻¹ and/or Cl⁻¹, the content in common to be [F⁻¹]+[Cl⁻¹]=Z.

Further, the ion content of group VII is: [Mn⁺²]+[Hal⁻¹]=2Z, and the value of the stoichiometric index Z is: 0.001≦Z≦0.003.

Further, the radiation of the light-storing phosphor causes a shortwave shifted in range λ=520˜475 nm subject to increase of stoichiometric index β^{1/2} due to the presence of Eu⁺² lattice.

Further, the group VII elements are aluminates base. When the content of the group VII elements in the aluminate matrix is increased, the afterglow persistence changes, and the absolute value reaches J=10 mcd.

Further, the powder shows a strip-like ellipse configuration, having a particle size about 3˜4 times of the maximum wavelength of the radiation spectrum of the phosphor, the medium size of the powder is d₅₀≦d_{cp}≦2.2 μm, and the maximum particle size is d₁₀₀≦10 μm.

To achieve this and other objects of the present invention, the light-storing phosphor preparation method of the present invention is the application of a heat treatment to an original acidiferous product, characterized in that the preparation of the acidiferous product is performed in an interaction between elements of group IIA metals and a matrix (host) of rare-earth hydroxide compound; the acidiferous product is processed in a fusion product of strong alkali; the heat process is a two-step heat treatment performed under the presence of a gas of weak reduction type

Further, the matrix (host) of rare-earth hydroxide compound contains a hydroxyl compound; the fusion product of strong alkali is based on Sr(OH)₂.8H₂O.Ba(OH)₂.8H₂O.

Further, the two-step heat treatment includes a first step heat treatment T₁>100° C. for a period of 0.5˜1 hour and a second step heat treatment T₂>1200° C. for a period of 1˜10 hours.

Further, water or acid solution forms the activating agent of the light-storing phosphor; when adding VII group elements to the phosphor composite, halogenate salt of manganese can be used.

Further, when the light-storing phosphor contains (Sr_{0.97}Mg_{0.02}Eu_{0.01}) (Al_{1.96}Mn_{0.002}Dy_{0.02}O_{3.998}F_{0.002}) and emits light in green spectral region, the afterglow persistence will be 3 hours, and the luminance, luminance will be L=10 mcd, and average particle size will be d_{cp}=1.36 μm.

Further, when the light-storing phosphor contains (Sr_{3.90}Ba_{0.06}Eu_{0.02}) (Al_{13.94}Mn_{0.02}Nd_{0.04}F_{0.02}) and emits light, the maximum persistence will be over 40 hours.

### DETAILED DESCRIPTION OF THE PREFERRED EMBODIMENT

The main object of the present invention is to eliminate the drawback of the aforesaid light-storing phosphor. To achieve this object, the invention provides a light-storing phosphor prepared from a matrix (host) based on aluminates of group IIA metals and activated by Eu⁺² and La⁺³, and characterized in that the composite of the light-storing phosphor contains group VII elements F⁻¹, Cl⁻¹, Mn⁺² and has the total stoichiometric equation of: (Me₁₋ₓEuₓO)_{α}(Al_{2-y-z}Ln⁺³_{y}Mn⁺²_{z}O_{3-z}Hal_{z})_{β}, in which Me=Sr and/or Ba and/or Ca and/or Mg, Ln=Dy and/or Nd and/or Ce, Hal=F and/or Cl;

wherein, when stoichiometric index α=1, stoichiometric index β has two values, i.e., β=1 or β=1.75, and at this time, the atomic fraction value of the element entering cation and anion lattices is: x=0.001˜0.1, y=0.001˜0.25, z=0.001˜0.005;

wherein the symbol Me represents Sr, Ba, Ca, Mg, they compose ΣMe=Sr_{1-p-q-r}BaₚCa_{q}Mgᵣ, in which p≦0.2, q≦0.2, r≦0.1, because Ln⁺³=Dy and/or Nd and/or Ce, symbol Hal⁻¹ represents F⁻¹ and/or Cl⁻¹, the content in common to be [F⁻¹]+[Cl⁻¹]=Z;

wherein the ion content of group VII is: [Mn⁺²]+[Hal⁻¹]=2Z, and the value of the stoichiometric index Z is: 0.001≦Z≦0.003.

A brief description on the discrimination in composition between the light-storing phosphor provided by the present invention and the prior art light-storing phosphor is given hereinafter. At first, the total stoichiometric equations of visible light green and sky blue sub-band radiation is provided. By means of modifying the stoichiometric index “β”, the basic formulas of two compounds are obtained. These two compounds composite the matrix (host) of the phosphor, such as: Me₁₋ₓEuₓOAl_{2-y-z}Ln⁺³_{y}Mn⁺²_{z}O_{4-z}Hal_{z} or Me₁₋ₓEuₓO(Al_{2-y-z}Ln⁺³_{y}Mn⁺²_{z}O_{4-z}Hal_{z})_{1.75}.

Thereafter, new chemical elements are added to the phosphor: Mn⁺² and halogen ions F⁻¹ and/or CI⁻¹.

Thereafter, in the relationship of the cation and anion ratio of the oxide of the phosphor lattice, i.e., the discrimination between the phosphor of the present invention and the prior art, for example, the extreme value of the key activator Eu⁺² is reduced to [Eu⁺²]=0.001 atomic fraction. At final, it is indicated that the comparative relationship between the oxide of the phosphor matrix (host) of the invention and that of the prior art can be expressed by integral number, for example, 1:1 or 4:7, as well as by fractional number, for example, (1−δ)/(1+δ). The aforesaid principle is helpful to light-storing phosphor manufacturers to fabricate more practical products in actual practice.

Similarly, subject to the substantial ion content in cation and anion lattices, the chemical composition of the phosphor can be accurately measured. In the light-storing phosphor provided by the present invention, the symbol Me represents Sr, Ba, Ca, Mg, they compose: ΣMe=Sr_{1-p-q-r}BaₚCa_{q}Mgᵣ, in which p≦0.2, q≦0.2, r≦0.1, because Ln⁺³=Dy and/or Nd and/or Ce, and the symbol Hal⁻¹ represents F⁻¹ and/or Cl⁻¹, and the content in common is: [F⁻¹]+[Ce⁻¹]=Z.

The discrimination of the attribute of every composition element added to the phosphor will be explained in the present invention. The material that simply contains Sr⁺² has the characteristics of green light emission and long afterglow (persistence). If Ba⁺² is used in the material to substitute for Sr⁺², the corresponding material radiation spectrum is shifted to the longwave yellow-green region. Ba⁺² that substitutes for Sr⁺² will cause the following condition, i.e., p≦0.2, when Ba⁺² content is high, for example, greater than 0.2, the crystal-like architecture of the matrix (host) of the phosphor will change, and this change is not expected.

Adding Ca⁺² to the matrix (host) of the phosphor will cause shift of the radiation spectrum to the shortwave region. The sky blue of the twilight time between daylight and night is easily recognizable. The concentration of Ca⁺² is preferably q≦0.2, or most preferably q≦0.1 because an excessive high value will cause change of the crystal-like architecture of the phosphor lattice. The concentration of the substitute Mg⁺² should not exceed by [Mg⁺²]≦0.1 because the key activator Eu⁺² has a relatively greater size τ_{Eu}≧1.22, and the solubility in Eu⁺² lattice will be substantially reduced if the concentration of Mg⁺² is excessively high. When added amount is accurately controlled subject to the introduced concentration, the phosphor thus obtained has a straight crystal-like structure, in which α=1 and β=1, when stoichiometric index is any other specific value, the crystal lattice structure (Sr₄ Al₁₄O₂₅) is similar to monoclinic architecture. It is to be understood that there are many nodes of Sr⁺² in the two architectures, and the activator Eu⁺² can be respectively allocated therein. According to the calculation of the present invention, when [Eu⁺²]=0.01, the concentration of active ions becomes 1×10²¹/cm³, this amount is too much. In the matrix (host) of CaS:EuSm, the concentration of active ions is 1×10¹⁸−1×10¹⁹/cm³. The high active center concentration in the phosphor provided by the present invention is one of the advantages of its physical properties.

VII group ion content is: [Mu⁺²]+[Hal⁻¹]=2Z. The best optimal value of this stoichiometric index is: 0.001≦Z≦0.003. According to the data of the present invention, the ion content of halogen compound is: [F⁻¹]+[Cl⁻¹]=Z. It is quite common to add F⁻¹ to a phosphor matrix (host). It is rare to add two halogen compounds in a phosphor matrix (host).

Two different compositions of phosphor are known: Me₁₋ₓEuₓOAl_{2-y-z}Ln⁺³_{y}Mn⁺²_{z}O_{4-z}Hal_{z} or Me₁₋ₓEuₓO(Al_{2-y-z}Ln⁺³_{y}Mn⁺²_{z}O_{4-z}Hal_{z})_{1.75}.

These two different compositions are substantially discriminatable in luminous color. When activated by Eu⁺², the composition having the spinel architecture of Mg₂Al₂O₄ emits green light and long green afterglow.

Under the activation of Eu⁺² and following the increasing of Al₂O₃ concentration in the crystal lattice, the phosphor of this composition radiates in blue green spectral region, and the maximum value of the spectrum is λ=475 nm. This shortwave displacement is a property of known phosphors.

These phosphors have another characteristic: when the matrix (host) is added with VII group Mn⁺², F⁻¹, Cl⁻¹, the afterglow persistence is changed. At this time, the time in which the luminance value of the phosphor products reach the specified value is prolonged. Normally, this specified value is J=2 mcd that is adopted for the safety technique series of international standards. Similarly, the natural standard of the luminance of the moon J=10 mcd may be adopted.

As stated above, when the two phosphors are added with Mn⁺², F⁻¹, Cl⁻¹, the time in which the luminance value of the phosphor products reach the specified value is prolonged. When the concentration of the added element reaches Z≦0.003 atomic fraction, increase in time period is observed.

Based on the above statement, we can understand that the main problem of the prior art light-storing phosphors is their greatly dispersed composition, and the particle size limits the use of the phosphors in textile and color paint fabrications. These fabrications require fine phosphors. In phosphor synthesis, the invention prepared phosphor samples having a fine particle size.

A light-storing phosphor prepared according to the present invention has the particle size of d₅₀≈1.5 μm and the average diameter of d_{cp}≈2.2 μm, and the radiation wavelength is increased by 4 times. Further, the medium diameter is d₅₀=1.5 μm, and the radiation wavelength will be increased by 3 times when the phosphor matrix (host) contains a high concentration of Al₂O₃.

The inequilibrium in the diameter curve of the particle size distribution of the light-storing phosphor expresses the possible grain growth process during heat process of the powder. However, it is to be understood, the maximum diameter value of the synthesized phosphor is: d_{100≦10} μm. This is a substantial decrease. The average diameter of the prior art phosphors is 20˜60 μm. The average diameter of the phosphors according to the present invention is d_{cp}≈2.2 μm.

Further, the invention also discloses a light-storing phosphor preparation method. The light-storing phosphor preparation method of the present invention is a heat process applied to an original acidiferous product, characterized in that the preparation of the acidiferous product is performed in an interaction between elements of group IIA metals and a matrix (host) of rare-earth hydroxide compound; the acidiferous product is processed in a fusion product of strong alkali; the heat process is a two-step heat treatment performed under the presence of a gas of weak reduction type;

wherein the matrix (host) of rare-earth hydroxide compound contains a hydroxyl compound; the fusion product of strong alkali is based on Sr(OH)₂.8H₂O,Ba(OH)₂.8H₂O;

wherein the two-step heat treatment includes a first step heat treatment T₁>100° C. for a period of 0.5˜1 hour and a second step heat treatment T₂>1200° C. for a period of 1˜10 hours;

wherein water or acid solution forms the activating agent of the light-storing phosphor; when adding VII group elements to the phosphor composite, halogenate salt of manganese can be used;

wherein when the light-storing phosphor contains (Sr_{0.97}Mg_{0.02}Eu_{0.01}) (Al_{1.96}Mn_{0.002}Dy_{0.02}O_{3.998}F_{0.002}) and emits light in green spectral region, the afterglow persistence will be 3 hours, and the luminance, luminance will be L=10 mcd, and average particle size will be d_{cp}=1.36 μm;

wherein when the light-storing phosphor contains (Sr_{3.90}Ba_{0.06}Eu_{0.02}) (Al_{13.94}Mn_{0.02}Nd_{0.04}F_{0.02}) and emits stored light, the maximum persistence will be over 40 hours.

An example of the preparation of the light-storing phosphor according to the present invention is explained hereinafter. At first, the invention does not select an oxide or carbonate for the original composite as that used in conventional methods, but uses hydroxides instead. The hydroxides have the data of Sr(OH)₂ T₁=370° C. (fusion temperature) and Ba(OH)₂ T₁=408° C. The hydroxides include their hydrated crystals, compound Sr(OH)₂.8H₂O and Ba(OH)₂.8H₂O. The invention utilizes the properties of these compounds, i.e., they will not be destructed when dissolved in their water molecules. Under this condition, high-concentration OH radical solutions are produced. Al(OH)₃ interacts with these solutions. Further, all other components are respectively added to the original composite, and their hydroxides are used in priority.

An example of the composite for the preparation of the phosphor is introduced as follows:

Sr(OH)₂: 0.96M

Eu(NO₃)₃.6H₂O: 0.02M

Mg(OH)₂: 0.02M

Al(OH)₃: 1.94M

Dy(OH)₃: 0.04M

MnClF: 0.02M

The aforesaid substances are mixed in the barrel of a 1500 r.p.m. planetary ball mill. Thereafter, the composite is put in a 500 mm alundum crucible on a heat-resisting silicon carbide kiln.

The kiln is charged with a gas mixture of hydrogen and nitrogen (95% N₂+5% H₂). During the first step heat treatment the temperature T₁ in the kiln enables the hydroxide of Sr and Ba to be melted, i.e., T1=110° C. At the same time, the molten hydroxide of Sr and Ba actively dissolve the composite. The hydroxide is dehydrated into anions Al₂O₄⁻² or 2AlO₂⁻¹.

In the hydroxide solution, europium hydroxide and dysprosium hydroxide, or europium and dysprosium are evenly distributed. The additive MnCIF is also dissolved in sodium hydroxide. When temperature reaches T>400° C., sedimentation of alkali-earth metal aluminate and manganese halogenide will appear.

After synthesis, Eu⁺³ is reduced into Eu⁺² at high temperature. Under this condition, Eu⁺³ is reconstructed in the lattice of cations in aluminate at the site of Sr⁺² or Ba⁺². The application of the of the present invention can also prepare other phosphors.

A general report of all phosphor composites are disclosed in Table I. Table I lists all phosphors and their characteristics.

TABLE 1

| | | | | Particle size: |
|---|---|---|---|---|
| | | | Luminous | d₁₀ d₅₀ |
| | | Glow color and | brightness | d_{cp} d₁₀₀ |
| | Chemical composite of phosphor | afterglow color | after 2 hours | (μm) |
| 1 | Sr_{0.96}Eu_{0.02}Mg_{0.02}Al_{1.94}Dy_{0.04}Mn_{0.02}(F⁻¹,Ce⁻¹)_{0.02}O_{3.998} | green | 12 | 0.48, 1.36, 2.54, 10.6 |
| 2 | Sr_{0.92}Ba_{0.06}Eu_{0.02}Al_{1.94}Dy_{0.04}Mn_{0.002}F⁻¹_{0.02}O_{3.998} | green | 14 | |
| 3 | Sr_{0.095}Ca_{0.03}Eu_{0.02}Al_{1.94}Dy_{0.04}Mn_{0.02}Ce⁻¹_{0.02}O_{3.998} | green | 16 | |
| 4 | (Sr_{3.90}Ba_{0.08}Eu_{0.02})Al_{13.9}Mn_{0.01}Nd_{0.04}F_{0.02}O_{24.99} | Blue-green | 8 | |
| 5 | (Sr_{3.88}Ca_{0.11}Eu_{0.01})Al_{13.9}Mn_{0.001}F_{0.001}O_{24.99} | Blue-green | 14 | |
| 6 | (S_{3.94}Mg_{0.02}Eu_{0.04})Al_{13.9}Mn_{0.001}Cl_{0.001}O_{24.99} | Blue-green | 12 | |
| 7 | (Sr_{0.89}Ba_{0.06}Eu_{0.05})Al_{1.89}Mn_{0.05}Dy_{0.1}F_{0.005}O_{3.995} | Green-blue | 10 | |
| 8 | SrAl₂O₄: Eu,Dy | green | 20 | 3.0, 22, 44, 100 |
| 9 | Sr₄Al₁₄O₂₅Eu,DyNd | Blue-green | 14 | 2.8, 1.8, 36, 65 |

It is indicated all over again, the medium diameter in the light-storing phosphor provided by the present invention is smaller than 20 times over than the samples from foreign companies, and the value of average diameter is smaller than 15 times over. The important parameter of the phosphor provided by the present invention is its significant and promising surface. In the various phosphor samples, the specific surface ranges from S=35×10³˜54×10³ cm²/cm³. To a standard phosphor sample, this value does not exceed by S≦5×10³ cm²/cm³.

In conclusion, the invention provides a light-storing phospho. The light-storing phosphor comprises a matrix (host) prepared from aluminates of group IIA metals. The powder shows strip-like ellipse configuration, having a particle size about 3˜4 times of the maximum wavelength of the radiation spectrum of the phosphor.

Although a particular embodiment of the invention has been described in detail for purposes of illustration, various modifications and enhancements may be made without departing from the spirit and scope of the invention.

What the invention claimed is:

1. A light-storing phosphor prepared from a matrix based on aluminates of ground IIA metals and activated by Eu⁺² and La⁺³, wherein the phosphor contains group VII elements F⁻¹, Cl⁻¹, Mn⁺² and has the total stoichiometric equation of: (Me₁₋ₓEuₓO)_{α}(Al_{2-y-z}Ln⁺³_{y}Mn⁺²_{z}O_{3-z}Hal_{z})_{β}, in which Me=Sr and/or Ba and/or Ca and/or Mg, Ln=Dy and/or Nd and/or Ce, Hal=F and/or Cl.

2. The light-storing phosphor as claimed in claim 1, wherein when stoichiometric index α=1, stoichiometric index β has two values, i.e., β=1 or β=1.75, and at this time, the atomic fraction value of the element entering cation and anion lattices is: x=0.001˜0.1, y=0.001˜0.25, z=0.001˜0.005.

3. The light-storing phosphor as claimed in claim 1, wherein the symbol Me represents Sr, Ba, Ca, Mg, they compose ΣMe=Sr_{1-p-q-r}BaₚCa_{q}Mgᵣ, in which p≦0.2, q≦0.2, r≦0.1, because Ln⁺³=Dy and/or Nd and/or Ce, symbol Hal⁻¹ represents F⁻¹ and/or Cl⁻¹, the content in common to be [F⁻¹]+[Cl⁻¹]=Z.

4. The light-storing phosphor as claimed in claim 1, wherein the ion content of group VII is: [Mn⁺²]+[Hal⁻¹]=2Z.

5. The light-storing phosphor as claimed in claim 1, wherein the value of the stoichiometric index Z is: 0.001≦Z≦0.003.

6. The light-storing phosphor as claimed in claim 1, wherein the radiation of the light-storing phosphor causes a shortwave shifted in range λ=520˜475 nm subject to increase of stoichiometric index β^{1/2} due to the presence of Eu⁺² lattice.

7. The light-storing phosphor as claimed in claim 1, wherein when the content of the group VII elements in the aluminate matrix is increased, the afterglow persistence changes, and the absolute value reaches J=10 mcd.

8. The light-storing phosphor as claimed in claim 1, wherein the powder shows a strip-like ellipse configuration, having a particle size about 3˜4 times of the maximum wavelength of the radiation spectrum of the phosphor.

9. The light-storing phosphor as claimed in claim 1, wherein the medium size of the powder is d₅₀≦d_{cp}≦2.2 μm, and the maximum particle size is d₁₀₀≦10 μm.
